(19) United States
(12) Patent Application Publication
(10) Pub. No.: US 2024/0046281 A1
(43) Pub. Date: Feb. 8, 2024

(54) PROVENANCE AND TOKENIZATION PLATFORM FOR HERITAGE GRAINS

(71) Applicant: Emergent Technology Ltd, Houston, TX (US)

(72) Inventors: Jason Dax Hansen, Bainbridge Island, WA (US); Youssef Sneifer, Kirkland, WA (US)

(21) Appl. No.: 18/258,807

(22) PCT Filed: Dec. 21, 2021
(86) PCT No.: PCT/US21/64727

§ 371 Date: Jun. 21, 2023

Related U.S. Application Data
(60) Provisional application No. 63/128,286, filed on Dec. 21, 2020.

(51) Int. Cl. G06Q 30/018; G06Q 20/38

(52) U.S. Cl. CPC G06Q 30/018; G06Q 20/3829; G06Q 20/389

(57) ABSTRACT

A system is provided that tracks provenance of items used in manufacturing of product so that the provenance of the items can be verified by a consumer. The system records in a distributed ledger transactions that identify the origin, originator, and characteristics of an item. The transaction including a signature of the originator that is generated using a private key of the originator. For other participants in the manufacturing of the product, each participant records in the distributed ledger transactions relating to manufacturing of the product. The transactions including a signature of the participant generated using a private key of the participant. The system receives from a consumer an identification of the product, collects transactions relating to product, verifies the transactions using public keys corresponding to the private keys, and provides to the consumer an indication of the provenance of the product.

### CROSS REFERENCE TO RELATED APPLICATION(S)

This application claims the benefit of priority to U.S. Provisional Patent Application No. 63/128,286, filed Dec. 21, 2020, which is incorporated herein by reference in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a username, social security number, and biometric data (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring, securing obligations) involving the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the corresponding blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

### BRIEF DESCRIPTION OF THE DRAWINGS

FIG. 1 is a block diagram that illustrates a computer system of participants in the Provenance and Tokenization Platform (PTP) system.

FIG. 2 illustrates recording of example transactions for a food or beverage supply chain.

FIG. 3 is a flow diagram that illustrates an example of the processing of a participant smart contract.

FIG. 4 is a flow diagram that illustrates an example of the processing of a validate seed bank transaction.

FIG. 5 is a flow diagram illustrates the processing of a consumer application in some embodiments.

FIG. 6 is a flow diagram that illustrates a check provenance component in some embodiments.

FIG. 7 is a flow diagram that illustrates the processing of a record purchase component.

FIG. 8 is a diagram that illustrates challenges some of which the PTP system overcomes in some embodiments.

FIG. 9 is a diagram that illustrates types of information the PTP system stores in a blockchain in some embodiments.

FIG. 10 is a diagram that illustrates benefits of the PTP system in some embodiments.

### DETAILED DESCRIPTION

A provenance and tokenization platform (“PTP”) system is provided that tracks provenance of target products such as grain and grain-based food and beverage products from farmer or seed supplier to mill or distillery or brewery to retailer and consumer. The PTP system may be employed to tokenize and track the provenance of any type of physical assets. In some embodiments, the PTP system provides a distributed ledger (e.g., blockchain) system that records transactions relating to target products. In the following, although the PTP system is described primarily in the context of a target product that is grain, the PTP system may be employed to track provenance any other types of products, components of products, and commodities in general. The participants of the PTP system include (for purposes of the descriptions that follow but without limitations) food supply chain participants such as seed bank operators, farmers, mill operators, brewers, distilleries, co-packers, distributors, wholesalers, retailers, restaurant operators, consumers, and so on. The PTP system provides smart contracts for each type of participant (e.g., farmers) for receiving transactions, validating transactions, and recording the transactions relating to the type of the participant in the distributed ledger. For example, a seed bank operator may record transactions representing seeds available for sale, sale of seeds to farmers, and so on. A seed transaction for available seeds provides details of the type of seed such as Sonora white wheat or Italian wheat, historical information about the seed (e.g., cultivated by native Americans in Arizona), and so on. The PTP system may provide applications that collect seed transactions for seed banks and provide a user interface that allows a user (e.g., farmer) to view information about the seeds and to place orders for seed. When a seed bank sells seed, the seed bank records a seed sale transaction indicating amount of seed, the purchaser, and so on. The seed sale transaction contains a reference to the seed bank transaction relating to the seed. When a farmer plants the seed, the farmer may record a crop transaction corresponding to the crop that includes a reference to the sale transaction. The farmer may also record crop growth transactions that contain information about the crop growth such as irrigation information, fertilization information, pesticide information, temperature information, crop rotation information, planting information, harvesting information, and so on. Each participant in the value chain records transactions relating to that participant's role in the food supply chain. The PTP system may be used with heritage grains, ancient grains, or any other type of grain whose provenance is to be tracked. The PTP system may be used to track the provenance of any type of tracked item such as a raw material, a product (manufactured or grown), a commodity (e.g., petroleum), and so on.

In some embodiments, the PTP system provides a consumer application that allows consumers to track the provenance of grain products that are available for purchase. For example, a mill operator may include a QR code on packages of grain (e.g., quinoa) that uniquely identifies the provenance of the grain. A consumer can use the consumer application (e.g., executing on a smart phone) to scan the QR code. The consumer application uses the QR code to identify a mill or distillery transaction of the mill or distillery operator relating to the grain, the mill, or the distillery. The mill transaction may reference a crop transaction which may reference a farmer transaction which may reference a seed bank transaction. The consumer application then displays the provenance information relating to the grain product.

In some embodiments, the PTP system may allocate tokens to consumers who purchase grain products from sellers such as from a box store retailer, an e-commerce retailer, a restaurant, and so on. Each consumer may have a digital wallet for storing the tokens. A consumer may use the tokens to purchase grain products. For example, if a consumer receives a token for the purchase of a pound or other unit of measure (e.g., kilogram for grain or barrel for whiskey), the consumer may pay for a pound of the grain using 10 tokens or may receive a 50% discount using five tokens. The PTP system may provide a retailer application (e.g., executing on a point-of-sale terminal) that interact with the consumer application to receive consumer information and record consumer sale transaction that also allocates tokens to the consumer. Alternatively, the packaging of the grain product may include another QR code, which may be inside the package. When a consumer purchases and opens the package, the consumer can use the consumer application to scan the QR code and record a consumer sale transaction that allocates tokens to the consumer. In addition, tokens for grains may be used to support digital securities offerings relating to the grain or distilled beverages made from that grain.

In some embodiments, the consumer application may support providing information on grains used in food items sold at a restaurant. For example, the menu at a restaurant may include a QR code for a food item that includes a grain. The consumer may use the consumer application to view provenance information for the grain. When the consumer purchases the food item, the consumer application may interact with a restaurant application to record a consumer purchase transaction in a manner similar to how a retailer would record a transaction as described above.

In some embodiments, the PTP system may provide a co-packer application that allows the co-packer to record transactions about the grains and other ingredients in a product. For example, if the product is pancake mix, the co-packer application may record one or more transactions identifying the ingredients. A transaction for a grain ingredient may reference a path of transactions that provide the provenance of the grain.

In some embodiments, the consumer application may provide a feedback option that allows consumers provide feedback to co-packers, mill operators, distillery operators, farmers, and so on relating to consumer demand for types of grain. For example, if many consumers express a desire to have pancake mix with a certain type of grain, that information may be used by participants in the supply chain to meet the demand. A co-packer may request a mill operator to provide that grain, and the mill operator may the request a farmer to provide that grain.

The PTP system may employ a permissioned distributed ledger. Each participant (except possibly consumers) may be required to provide proof that they are an authentic participant. For example, a mill operator may need to be authenticated by, for example, proof of ownership of the mill. Each participant may have a public/private key pair and sign transactions with their private key. Other participants can use the public key of the participant to authenticate transactions recorded by that participants. The PTP system allows fraudulent transactions to be identified. For example, if a mill operator attempts to record transactions for 10 tons of a certain grain but only purchased 5 tons of the grain, an analysis of the distributed ledger will identify this fraud. In addition, a mill operator smart contract may be used to identify seemingly fraudulent transactions and not record those transactions or send a notification to the operator of the distributed ledger of the fraudulent transaction. The operator of the distributed ledger may investigate and revoke the permission of the mill operator.

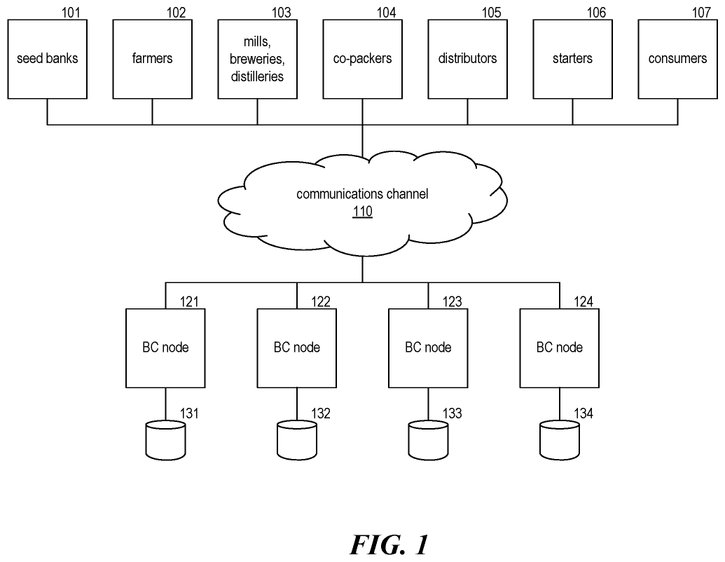

FIG. 1 is a block diagram illustrating a computer system of participants in the PTP system. Each participant may have an application 101-107 that is specific for that participant. For example, a farmer application interacts with a farmer smart contract to record farmer transactions. The applications are connected to a communications channel 110 (e.g., the internet) for recording and accessing transactions of the distributed ledger. The distributed ledger may be maintained by blockchain nodes 121-124 that record transactions in the distributed ledger. Each blockchain node may include a copy 131-134 of the distributed ledger. The blockchain nodes may also function as mining nodes of the blockchain. The mining nodes may use a consensus algorithm (e.g., proof of work, proof of stake) to maintain the blockchain. The mining nodes may be allocated mining tokens based on their successful mining efforts. The mining token may be the same as tokens award to consumer and be used to purchase product. Each participant in the blockchain may use tokens to purchase grain items from other participants in the food supply chain. The participants in the blockchain may operate the blockchain nodes. Each participant may store a portion of the blockchain relating to its products to allow more rapid access to transaction information by consumer applications.

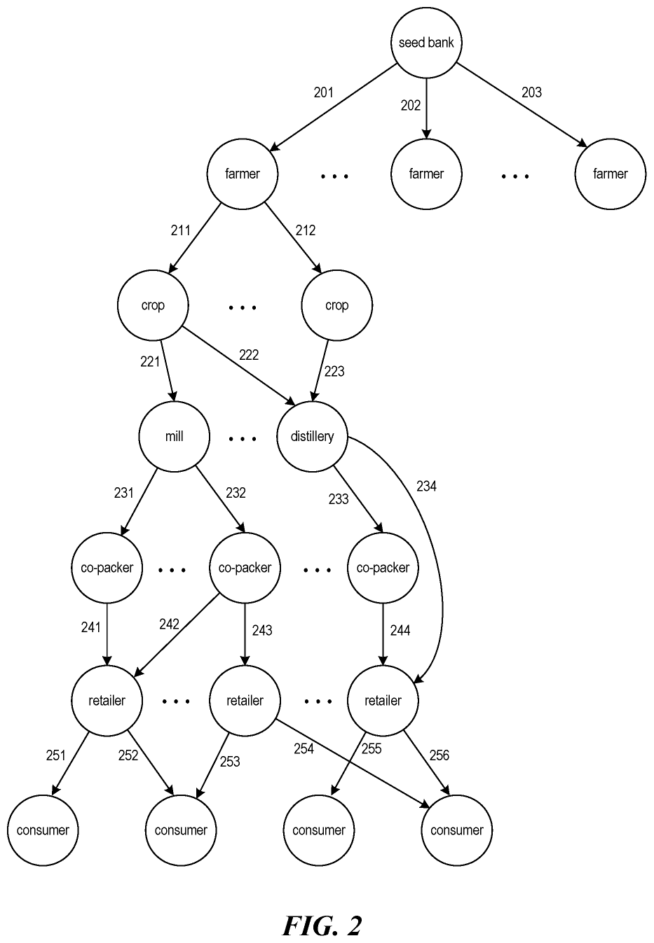

FIG. 2 illustrates recording of example transactions for a food or beverage supply chain. A seed bank operator may record transactions relating to seeds (not shown) and transactions 201-203 relating to sale of seeds to farmers. A farmer may record transactions 211-212 relating to crops. When a grain from a crop is sold, the farmer may record transactions 221-223 relating to sale of the crops. The mill operators or distilleries may record transactions 231-234 relating to sale of milled grain or alcohol or non-alcoholic distilled beverage. Co-packers and retailer may also record transactions. A consumer can use the consumer application to identify the provenance of grain. For example, a consumer can follow the path 251, 241, 231, 221, and 201 to identify the provenance of grain.

The computing systems (e.g., network nodes or collections of network nodes) on which the PTP system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the secure payment system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The PTP system may be described in the general context of computer-executable instructions, such as program modules and components, executed by one or more computers, processors, or other devices. Generally, program modules or components include routines, programs, objects, data structures, and so on that perform tasks or implement data types of the PTP system. Typically, the functionality of the program modules may be combined or distributed as desired in various examples. Aspects of the secure payment system may be implemented in hardware using, for example, an application-specific integrated circuit (“ASIC”) or field programmable gate array (“FPGA”).

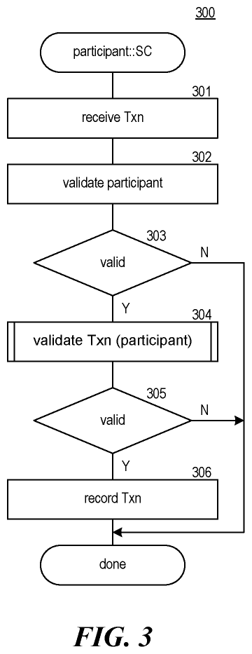

FIG. 3 is a flow diagram that illustrates processing of a participant smart contract. A component 300 receives a transaction, validates the transaction, and records the transaction in the blockchain. In block 301, the component receives a transaction such as a transaction recorded by a seed bank operator. In block 302, the component validates the participant, for example, by checking the signature on a transaction. In decision block 303, if the participant is valid, then the component continues at block 304, else the component completes. In block 304, the component invokes a validate transaction component for the type of participant. In decision block 305, if the transaction is valid, then the component continues at block 306, else the component completes. In block 306, the component records the transaction and then completes.

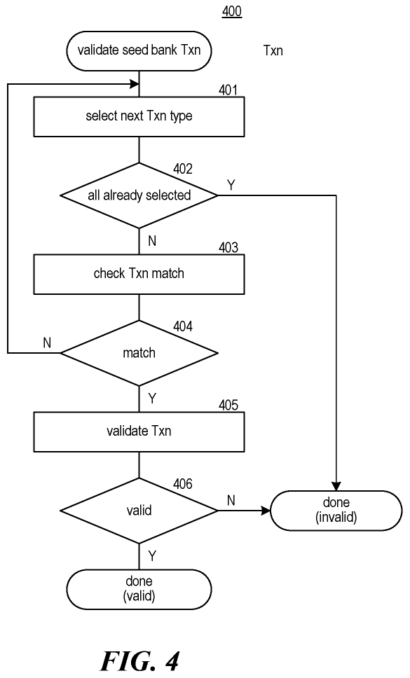

FIG. 4 is a flow diagram that illustrates the processing of a validate seed bank transaction. A component 400 receives a transaction and returns an indication of whether the transaction is valid. In blocks 401-404, the component loops identifying the types of transaction. In block 401, the component selects the next type of transaction that can be recorded by a seed bank operator. In decision block 402, if all the transaction types of already been selected, then the component completes indicating that the transaction is invalid, else the component continues at block 403. In block 403, the component checks the transaction to see if it matches the selected transaction type. In decision block 404, if the transaction matches, then the transaction is for a valid type and the component continues at block 405, else the component loops to block 401 to select the next transaction type. In block 405, the component validates the transaction body, for example, ensuring that all the fields of the transaction have valid values. In decision block 406, if the transaction is valid, then the component completes indicating that the transaction is valid, else the component completes indicating that the transaction is invalid.

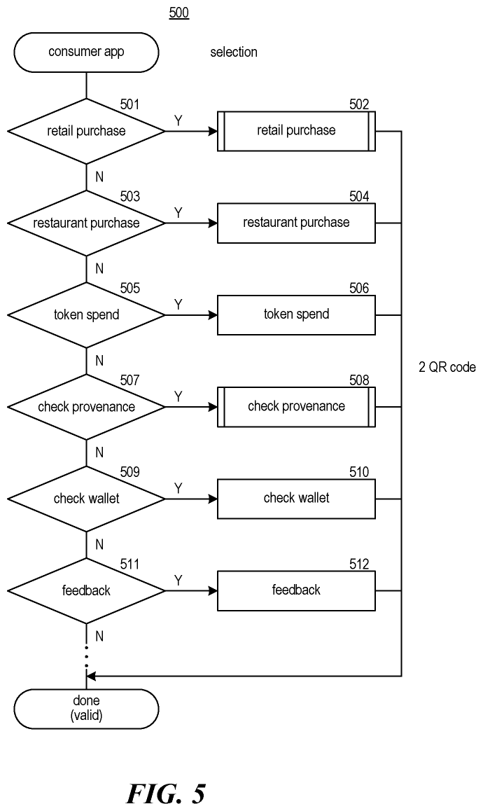

FIG. 5 is a flow diagram illustrates the processing of a consumer application in some embodiments. A component 500 is invoked along with a selection of the function to be performed. In decision block 501, if the selection is for retail purchase, then the component continues at block 502 to process a retail purchase. In decision block 503, if the selection is a restaurant purchase, then the component continues at block 504 to process a restaurant purchase, else the component continues at block 505. In decision block 505, if the selection is a token spent, then the component continues at block 506 to perform the token spend function, else the component continues at block 507. In decision block 507, if the selection is a check provenance, then the component continues at block 508 to check the provenance, else the component continues at block 509. In decision block 509, if the selection is a check wallet, then the component continues at block 510 to perform a check wallet function such as display number of tokens and history of token purchases, else the component continues at block 511. In decision block 511, if the selection is to provide feedback, then the component continues at block 512 to solicit feedback, else the component check for any other selections as indicated by the ellipsis and then completes.

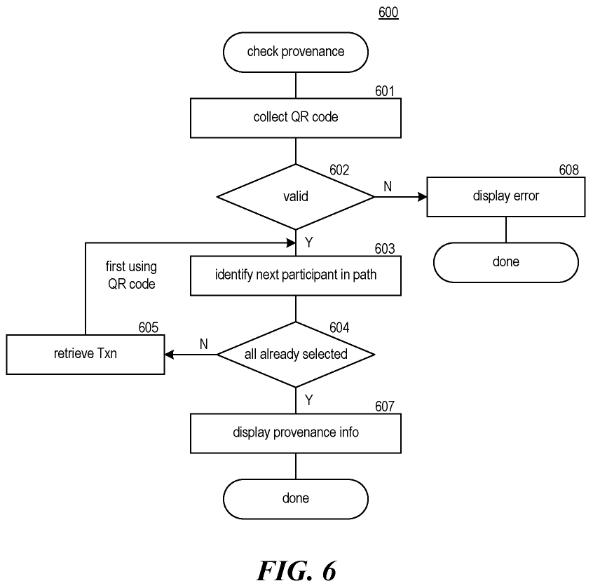

FIG. 6 is a flow diagram that illustrates a check provenance component in some embodiments. A check provenance component 600 is invoked when a consumer selects to check the provenance of a grain. In block 601, the component may collect a QR code, for example, from the outside of a package that contains the grain. In decision block 602, if the QR code is valid, then the component continues at block 603, else the component continues at block 608. A QR code may be valid if it is tied to a transaction in the blockchain. In block 603, the component identifies the next participant in the path from the product to the seed bank. In decision block 604, if all the participants have already been selected, then the component continues at block 607, else the component continues at block 605. In block 605, the component retrieves the next transaction in the path for the selected participant and then loops to block 603 to identify the next participant. In block 607, the component displays the provenance information and then completes. In block 608, the component displays an error and then completes.

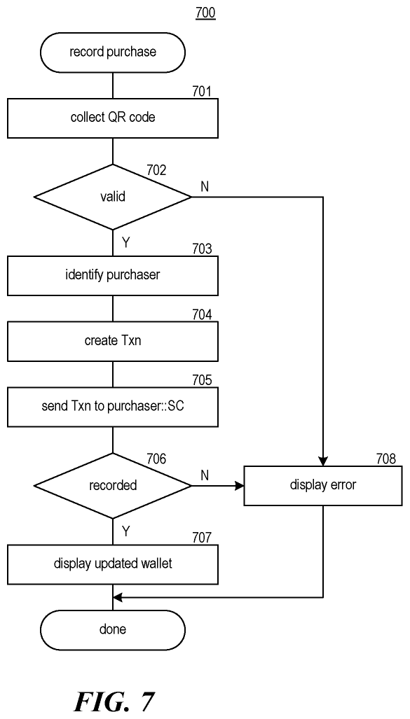

FIG. 7 is a flow diagram that illustrates the processing of a record purchase component. A record purchase component 700 is invoked when a consumer selects to record a purchase. In block 701, the component selects a QR code, for example, from the inside of a package that the consumer purchase. In block 702, the QR code is valid, the component continues at block 703, else the component continues at block 708. In block 703, the component identifies the purchaser. In block 704, the component creates a purchase transaction. In block 705, the component sends the purchase transaction to the purchase smart contract for recording in the blockchain and allocating tokens. In decision block 706, if the transaction was recorded, then the component continues at block 707, else the component continues at block 708. In block 707, the component displays the updated wall to the purchaser and then completes. In block 708, the component displays an error and then completes.

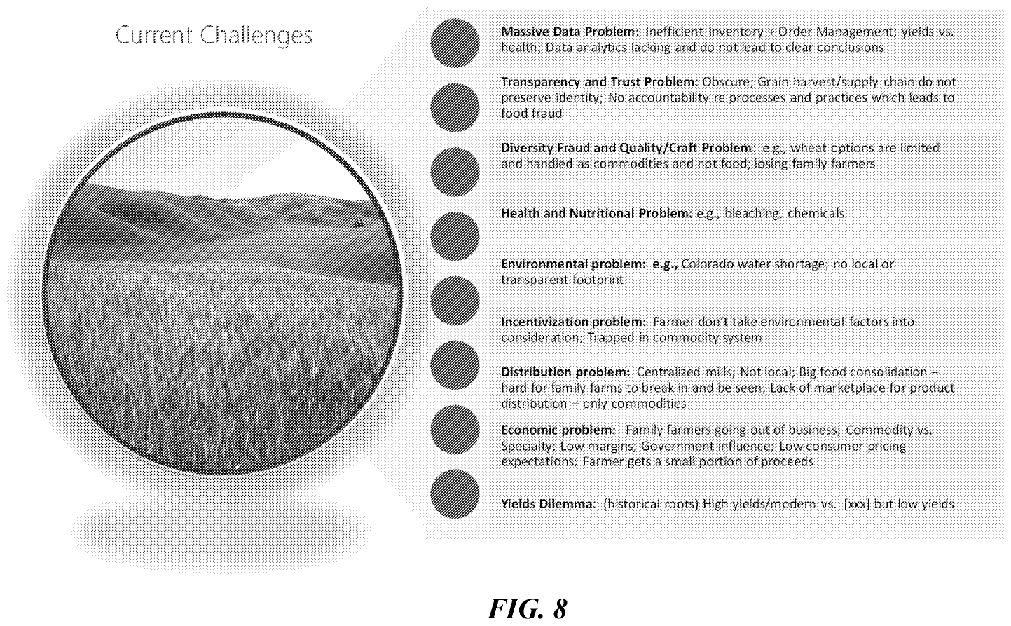

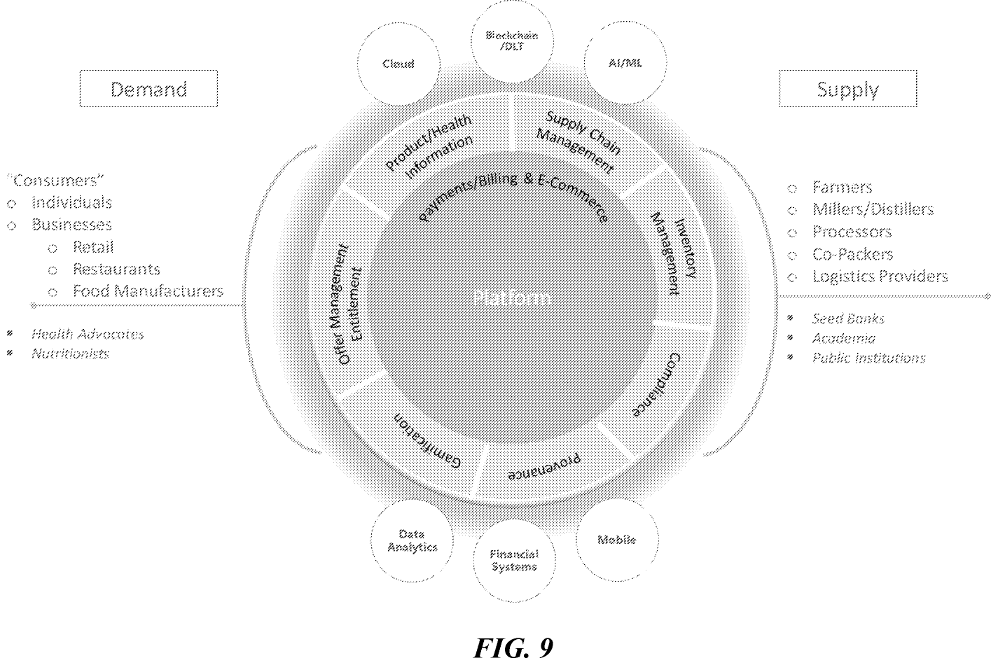

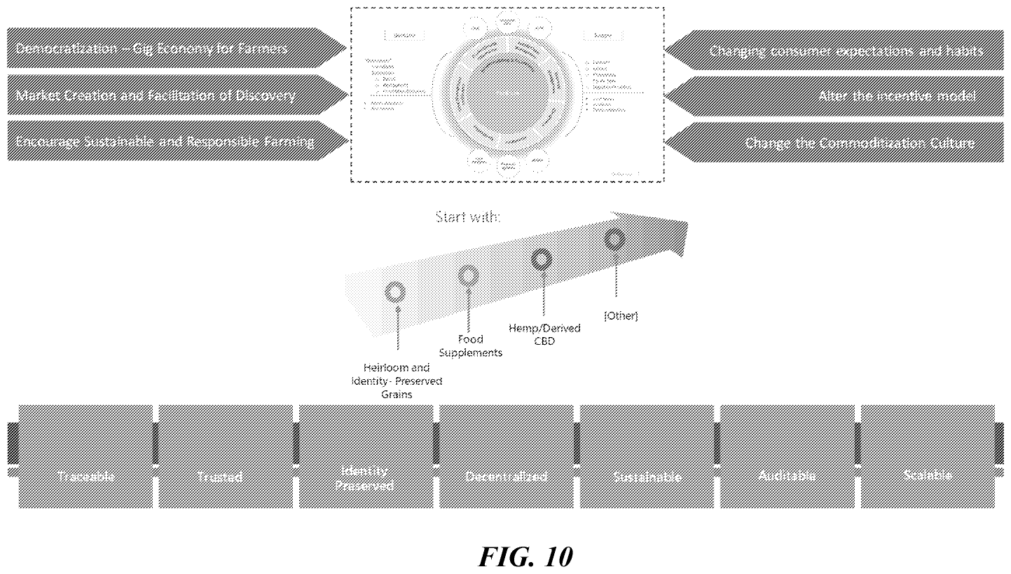

FIG. 8 is a diagram that illustrates challenges some of which the PTP system overcomes in some embodiments. FIG. 9 is a diagram that illustrates types of information the PTP system stores in a blockchain in some embodiments. FIG. 10 is a diagram that illustrates benefits of the PTP system in some embodiments.

The following paragraphs describe various embodiments of aspects of the PTP system. An implementation of the PTP system may employ any combination of the embodiments. The processing described below may be performed by a computing device with a processor that executes computer-executable instructions stored on a computer-readable storage medium that implements the PTP system.

In some embodiments, a method performed by one or more computing systems is provided for securely tracking provenance of tracked items. The method records in a blockchain a transaction relating to provenance of a tracked item, the transaction referencing a tracked item identification of the tracked item and a transaction relating to environmental factors relating to acquisition of the tracked item. The method, under control of each of a plurality of participants who perform processing relating to the tracked item, records in the blockchain a transaction relating to delivery of the tracked item to that participant. The transaction references a delivery identification and is signed using a private key of a public/private keypair of the participant who directs the delivery. The method records in the blockchain a transaction relating to processing relating to the tracked item that is performed by that participant. Transaction references a processing identification and is signed by a private key of a private/public key pair of that participant. The method receives from a consumer who purchases a product relating to the tracked item a product identification relating to the tracked item, identifies based on the product identification relating to the tracked item transactions relating to provenance of the tracked item, verifies the identified transactions using a public keys of participants, and displays to the consumer provenance information derived from the verified transactions. In some embodiments, the tracked item is a grain seed, and the processing actions include harvesting and delivery of the grain seed to a mill, milling and delivery of grain to a packer, and packing and delivery of the grain to a retailer. In some embodiments, a QR code is affixed to packaging of the product and the product identification is derived from the QR code. In some embodiments, multiple transactions relating to processing by a single participant identify constituents of product that includes the tracked item.

In some embodiments, a method performed by one or more computing systems is provided for securely tracking provenance of tracked items. The method records in a distributed ledger a transaction relating to the tracked item, the transaction identifying an originating participant and including a signature generated using a private key of a public/private keypair of the originating participant. The method records in the distributed ledger a transaction relating delivery of the tracked item to another participant in the blockchain. The transaction including a signature generated using a private key of a public/private keypair of the other participant. The method, under control of each of a plurality of participants who perform processing relating to the tracked item, record in the distributed ledgers a transaction relating to processing of a product that is derived from the tracked item that is performed by that participant. The transaction references a processing identification of the processing and an identification of the participant and includes a signature generated using a private key of a private/public key pair of that participant. The method records in the distributed ledger a transaction relating to delivery of the product that is derived from the tracked item to another participant. The transaction referencing a delivery identification and includes a signature generated using a private key of a public/private keypair of the participant who directs the delivery.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by one or more computing systems for securely tracking provenance of tracked items, the method comprising:
recording in a blockchain a transaction relating to provenance of a tracked item, the transaction referencing a tracked item identification of the tracked item;
recording in the blockchain a transaction relating to environmental factors relating to acquisition of the tracked item;
under control of each of a plurality of participants who perform processing relating to the tracked item,
recording in the blockchain a transaction relating to delivery of the tracked item to that participant, the transaction referencing a delivery identification, the transaction signed using a private key of a public/private keypair of the participant who directs the delivery; and
recording in the blockchain a transaction relating to processing relating to the tracked item that is performed by that participant, the transaction referencing a processing identification, the transaction being signed by a private key of a private/public key pair of that participant;
receiving from a consumer who purchases a product relating to the tracked item a product identification relating to the tracked item;
identifying based on the product identification relating to the tracked item transactions relating to provenance of the tracked item;
verifying the identified transactions using a public keys of participants; and
displaying to the consumer provenance information derived from the verified transactions.

2. The method of claim 1 wherein the tracked item is a grain seed, and the processing actions include harvesting and delivery of the grain seed to a mill, milling and delivery of grain to a packer, and packing and delivery of the grain to a retailer.

3. The method of claim 1 wherein a QR code is affixed to packaging of the product and the product identification is derived from the QR code.

4. The method of claim 1 wherein multiple transactions relate to processing by a single participant to identify constituents of product that includes the tracked item.

5. A method performed by one or more computing systems for securely tracking provenance of tracked items, the method comprising:
recording in a distributed ledger a transaction relating to the tracked item, the transaction identifying an originating participant and signed using a private key of a public/private keypair of the originating participant;
recording in the distributed ledger a transaction relating delivery of the tracked item to another participant in the distributed ledger, the transaction signed using a private key of a public/private keypair of the other participant; and
under control of each of a plurality of participants who perform processing relating to the tracked item,
recording in the distributed ledger a transaction relating to processing of a product that is derived from the tracked item that is performed by that participant, the transaction referencing a processing identification of the processing and an identification of the participant, the transaction being signed using a private key of a private/public key pair of that participant; and
recording in the distributed ledger a transaction relating to delivery of the product that is derived from the tracked item to another participant, the transaction referencing a delivery identification, the transaction signed using a private key of a public/private keypair of the participant who directs the delivery.
